(19) United States
(12) Patent Application Publication
(10) Pub. No.: US 2009/0144247 A1
(43) Pub. Date: Jun. 4, 2009

(54) Point-of-interest panning on a displayed map with a persistent search on a wireless phone using persistent point-of-interest criterion

(76) Inventors: Eric Wistrand, Antioch, CA (US); Kevin Sebastian, Union City, CA (US); John Hahn, San Francisco, CA (US); Regan Gill, Berkeley, CA (US); Kevin Tsurutome, San Francisco, CA (US); Robert Barcklay, Berkeley, CA (US)

Correspondence Address: MANELLI DENISON & SELTER PLLC, 7th Floor, 2000 M Street, N.W., Washington, DC, 20036-3307, US

(21) Appl. No.: 12/292,041

(22) Filed: Nov. 10, 2008

Related U.S. Application Data
(60) Provisional application No. 60/996,308, filed on Nov. 9, 2007.

(51) Int. Cl. G06F 17/30

(52) U.S. Cl. 707/3; 707/E17.014

(57) ABSTRACT

A persistent point-of-interest search is performed during map panning. A persistent search criteria module identifies a search criteria from a first mapping tile request and stores the search criteria in association with a particular wireless device. A mapping tile module identifies a neighboring mapping tile from a second mapping tile request and performs a point-of-interest search for the neighboring mapping tile with the stored search criteria. In this manner, a user need only enter a search criteria for a point-of-interest once, the point-of-interest being displayed automatically for subsequent map tiles displayed for the user.

The present invention claims priority from U.S. Provisional Application 60/996,308, filed Nov. 9, 2007, entitled “POINTS-OF-INTEREST PANNING ON A DISPLAYED MAP WITH A PERSISTENT SEARCH ON A WIRELESS PHONE USING PERSISTENT POINTS-OF-INTEREST CRITERION”, to Wistrand et al., the entirety of which is expressly incorporated herein by reference.

### BACKGROUND OF THE INVENTION

1. Field of the Invention

This invention relates generally to wireless telecommunication. More particularly, it relates to location based services (LBS), and persistent point-of-interest search and display techniques in wireless applications that enable viewing by a user of a wireless device.

2. Background of the Related Art

Currently with mobile phones, a user can search for point-of-interest icons based on user selected criterion. The user may view the resultant point-of-interest as icons on a map where the location of an icon is representative of the location (street address) of the corresponding point-of-interest. This map view is however static in that the user cannot simply pan to an adjacent map area and view the points-of-interest of the same criterion.

The user must back out of the map screen showing the point-of-interest they have selected and subsequently query for a point-of-interest of the same criterion yet they must somehow specify that they would like to see point-of-interest for a map area that is contiguous with the preceding mapped region of points-of-interest. Finding the contiguous region is nearly impossible in existing products. Also current products require a user to perform too many steps in order to acquire point-of-interest meeting their criterion in adjacent map area.

When a map is displayed in a wireless device using a conventional application, typically a map is somewhat larger than the size of the display screen it is downloaded and displayed on. However, existing map display applications are a bit cumbersome to use on a wireless device, as they typically do not allow the user to fluidly pan around a map that is being displayed at the time.

FIG. 7 shows a plurality of tiles that conventionally make up a prior art larger map area. In particular, as shown in FIG. 7, a plurality of tiles 710-790 make up a larger map area. Tile 710 is loaded into memory of a wireless device, such as a cell phone. Upon initial startup of the relevant application, the central tile 710 is loaded first and displayed. The central tile includes various points-of-interest 715. Points-of-interest 715 can include any of a variety of points-of-interest such as address(es), restaurant(s), mass transit station(s), shopping, hospital(s)s, park(s), etc. A user typically enters a search criteria or selects a menu option criteria on the wireless device 700 to display desired points-of-interest 715.

Presuming the user has not yet panning on the wireless device, the displayed tile 710 is generally downloaded or fetched first, followed by tiles 720-790 as the user pans to an edge of displayed tile 710. When a user pans to the edge of displayed tile 710, the previously loaded image is typically deleted from memory, and replaced with a new image tile, any of tiles 720-790 depending upon the direction of panning. Unfortunately, conventionally only the initially downloaded central tile 710 is displayed with the user's designated points-of-interest 715. A user may view map details for surrounding tiles 720-790, but the points-of-interest 715 from the initially displayed tile 710 are not viewable as a user pans from the displayed tile 710. When a user pans to any of neighboring tiles 720-790, those tiles do not continue to contain the user designated point-of -interest 715.

The user must back out of the map screen showing the points-of-interest 715 they have selected and subsequently query for points-of-interest 715 of the same criterion again, yet they must somehow specify that they would like to see points-of-interest 715 for a map area that is contiguous with the preceding mapped region of points-of-interest 715. Finding the contiguous region is nearly impossible in existing products. Also current products require a user to perform too many steps in order to acquire points-of-interest 715 meeting their criterion in adjacent map area.

There is a need for panning, on a wireless device, that allows for persistent points-of-interest that were originally displayed on a first tile displayed for a user. Point-of-interest criteria specified by a user is used to automatically add a point-of-interest to adjacent contiguous tiles to a tile that is currently being displayed for a user.

### SUMMARY OF THE INVENTION

In accordance with the principles of the present invention, a system for performing a persistent point-of-interest search comprises a persistent search criteria module. The persistent search criteria module identifies a search criteria from a first mapping tile request and stores the search criteria in association with a particular wireless device. A mapping tile module identifies a neighboring mapping tile from a second mapping tile request and performs a point-of-interest search for the neighboring mapping tile with the stored search criteria.

In accordance with another aspect of the invention, a method of performing a persistent point-of-interest search comprises identifying a search criteria from a first mapping tile request. The search criteria is stored in association with a particular wireless device. A neighboring mapping tile is identified from a second mapping tile request. A point-of-interest search is performed for the neighboring mapping tile with the stored search criteria.

### BRIEF DESCRIPTION OF THE DRAWINGS

FIG. 1 shows a system for providing persistent points-of-interest during panning, in accordance with the principles of the present invention.

FIG. 2 shows a detailed view of a mapping server, in accordance with the principles of the present invention.

FIG. 3 is a flow chart for a process of retrieving persistent search criteria during panning, in accordance with the principles of the present invention.

FIG. 4 shows an exemplary RasterLayer, in accordance with the principles of the present invention.

FIG. 5 shows an exemplary IconLayer, in accordance with the principles of the present invention.

FIG. 6 shows a plurality of mapping tiles that make up a larger map area, in accordance with the principles of the present invention.

FIG. 7 shows a plurality of tiles that conventionally make up a prior art larger map area.

### DETAILED DESCRIPTION OF ILLUSTRATIVE EMBODIMENTS

The present invention provides persistent point-of-interest display during panning on a wireless device. During an initial request for a tiled map from the wireless device that includes a point-of-interest search criteria, the point-of-interest search criteria is stored for future reference. The point-of-interest search criteria is stored in association with a particular wireless device. During a request for a neighboring tiled map from the same wireless device, the stored point-of-interest search criteria is retrieved and used to indentify a point-of-interest for the neighboring tiled map. The point-of-interest for the neighboring tiled map together with the neighboring tiled map is transmitted to the wireless device.

The present invention has particular applicability for use in wireless devices because of the typically smaller display screens requiring the need for panning.

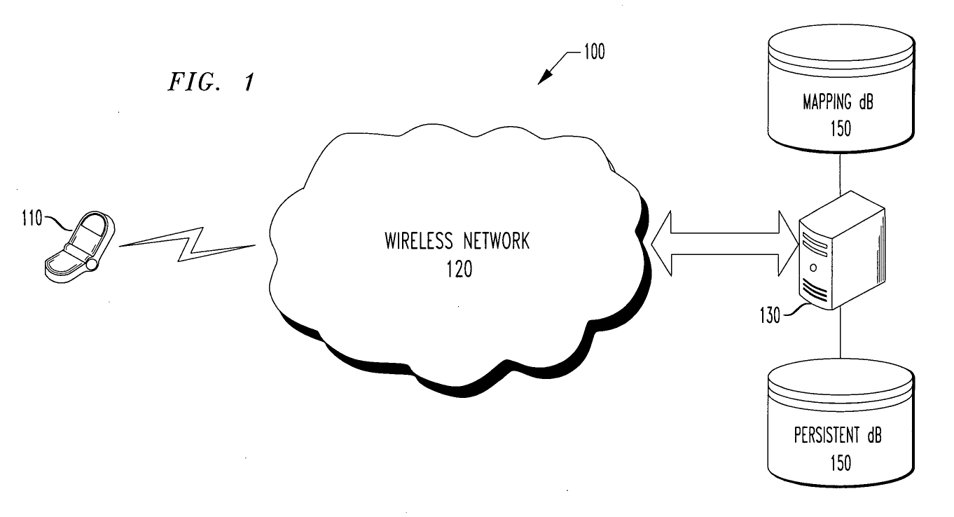

FIG. 1 shows a system for providing persistent points-of-interest during panning, in accordance with the principles of the present invention.

In particular, the system 100 for providing persistent points-of-interest during panning includes a wireless device 110, and a wireless network 120. In accordance with the principles disclosed herein, a tiled map retrieval system includes a mapping server 130, a mapping database 150, and a persistent database 140.

Wireless device 110 downloads map tiles and point-of-interest data from a mapping server 130. Wireless device 110 formulates a request for a mapping tile and point-of-interest data based on any number of search criteria that can include address(es), restaurant(s), mass transit station(s), shopping, hospital(s)s, park(s), etc. The request is transmitted over the wireless network 120 to mapping server 130. The mapping server 130 formulates a mapping database 150 query from the search criteria provided in the request for a mapping tile from the wireless device 110. The mapping tile returned from the mapping database 150 is formulated into one or more appropriate data packets and transmitted to the wireless device 110. The retrieval of a mapping tile and point-of-interest data from a mapping server 130 by a wireless device 110 is well known within the art.

In accordance with the principles disclosed herein, the mapping server 130 further stores the search criteria to be used during subsequent retrieval of neighboring mapping tiles during panning on a wireless device 110. The search criteria and associated identification of a wireless device (e.g., mobile identification number or MIN) are stored in persistent database 140.

Panning to an edge of a currently displayed mapping tile triggers wireless device 110 to transmit a request for a neighboring mapping tile. Conventionally, neighboring mapping tiles are not displayed with persistent point-of-interest criteria displayed. However, in accordance with the principles disclosed herein, a request for a neighboring mapping tile automatically triggers mapping server 130 to perform a search in a persistent database 140 for a previously received search criteria that is associated with a particular MIN. The previously stored search criteria retrieved from persistent database 140 is used to add point-of-interest icons related to a retrieved persistent search criteria. The point-of-interest icons together with a neighboring mapping tile are packaged together for transmission to a requesting wireless device 110.

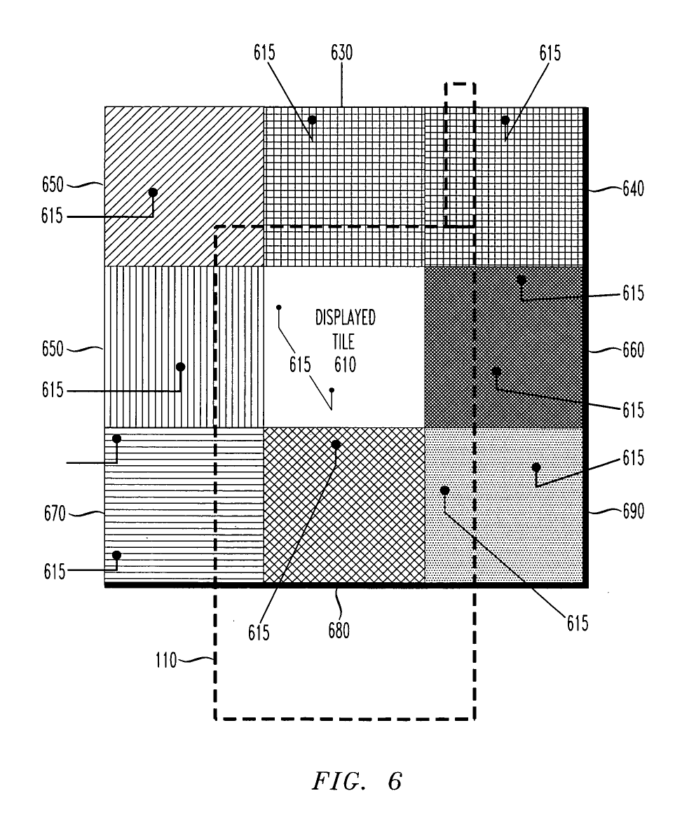

The neighboring mapping tile and its associated icon(s) for point-of-interest, shown in more detail in FIG. 6, are transmitted to the wireless device 110. In this manner, a user must enter search criteria for a point-of-interest only once. During panning operations on the wireless device 110, point-of-interest icon(s) is/are automatically provided on a neighboring mapping tile without the user having to re-enter search criteria. This saves a user a substantial amount of time from having to re-enter search criteria for each map tile that is displayed on the wireless device 110 during panning.

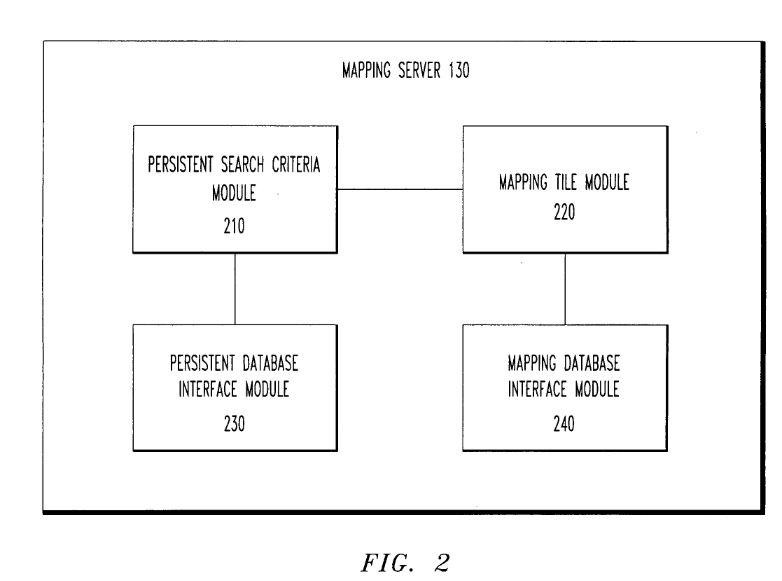

FIG. 2 shows a detailed view of a mapping server, in accordance with the principles of the present invention.

In particular, the mapping server 130 includes a persistent search criteria module 210, a mapping tile module 220, a database interface module 230, and a mapping database interface module 240.

The persistent search criteria module 210 can communicate with a wireless device 110. The persistent search criteria module 210 can accept a search criteria from a wireless device 110 and direct the search criteria be stored in association with a particular wireless device 110 for future reference in persistent database 140. Upon the mapping server 130 receiving a request for a mapping tile that is adjacent to a current viewed mapping tile, i.e., during panning, the search criteria module 210 can formulate a request for an appropriate mapping tile and retrieve the previously stored search criteria. The previously stored search criteria can be used to retrieve points-of-interest that match the search criteria from the mapping database 150.

The mapping tile module 220 can formulate a database query to retrieve appropriate mapping tiles from a mapping database 150. Moreover, the mapping tile module 220 can formulate a database query to retrieve appropriate points-of-interest from the mapping database 150 based on newly received search criteria and previous search criteria stored in persistent database 140.

Persistent database interface module 230 can provide an interface between the persistent database 140 and the persistent search criteria module 210. The persistent database interface module 230 can accept a persistent database 140 query from the persistent search criteria module 210 and provide the appropriate low level data communications to pass the query to the persistent database 140. Upon the persistent database 140 finding an appropriate match in response to a database query, the persistent database interface module 230 provides the appropriate low level data communications to allow the mapping server 130 to communicate with the persistent database 140.

The mapping database interface module 240 can provide an interface between the mapping database 150 and the mapping tile module 220. The mapping database interface module 240 can accept a mapping database 150 query from the mapping database interface module 240 and provide the appropriate low level data communications to pass the query to the mapping database 150. Upon the mapping database 150 finding an appropriate match in response to a database query, the mapping database interface module 240 provides the appropriate low level data communications to allow the mapping server 130 to communicate with the mapping database 150.

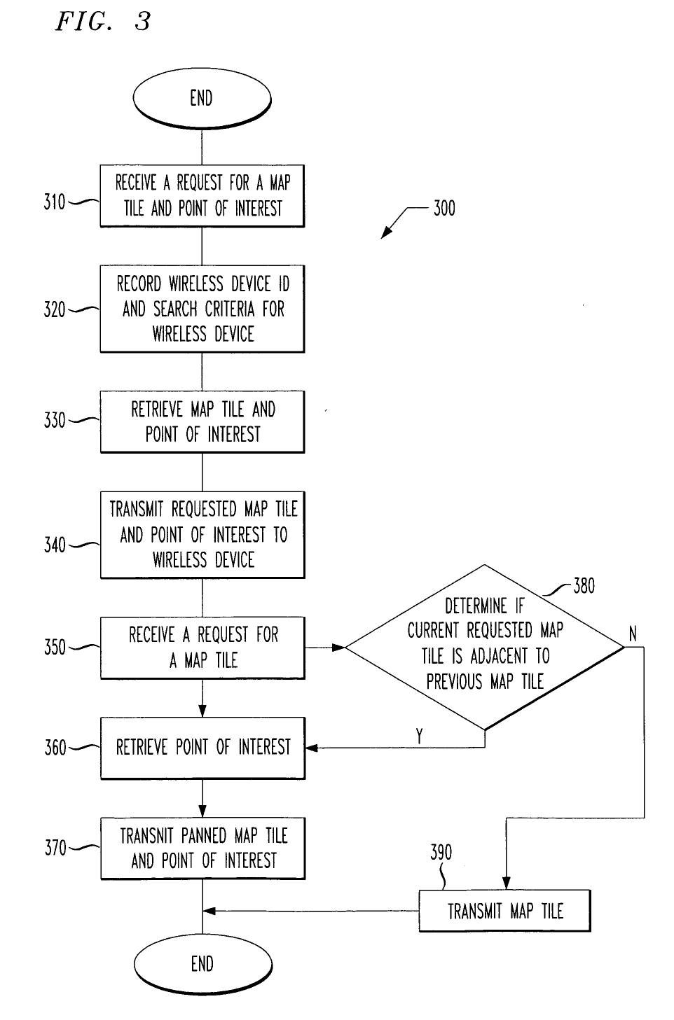

FIG. 3 is a flow chart for a process 300 of retrieving persistent search criteria during panning, in accordance with the principles of the present invention.

At step 310, a request for a mapping tile and at least one search criteria for a point-of-interest can be received by a mapping server 130. The mapping server 130 can receive one or more data packets that include the request for a mapping tile and the search criteria for a point-of-interest from a wireless device 110. If the request for a mapping tile and the search criteria for a point-of-interest is received as fragmented packets and/or as out-of-order packets, the persistent search criteria module 210 can re-order and/or reassemble the received packets to reconstruct the request for a mapping tile and search criteria. The mapping server 130 records the identification of the wireless device 110 that initiated a request for a mapping tile and one or more point-of-interest to allow a return of the requested data to the requesting wireless device 110.

At step 320, the mapping server 130 can direct storage of the received one or more search criteria for a point-of-interest from step 310 together with an associated wireless device identification, e.g., MIN. Mapping server 130 stores the search criteria and its associated wireless device identification in persistent database 140.

At step 330, the mapping server 130 can communicate with mapping database 150 to retrieve a requested map tile and one or more point-of-interest. The mapping server 130 formulates an appropriate database query, as is known within the art, from the request for a mapping tile and search criteria received in step 310.

At step 340, the mapping server 130 transmits the mapping tile and icon(s) for point-of-interest, based on a received search criteria, to the wireless device 110 issuing a request for a mapping tile and a request for point-of-interest in step 310.

At step 350, the mapping server 130 receives another request for a mapping tile from the same wireless device that issued the request in step 310. The mapping server 310 can extract identification information, e.g., mobile identification number (MIN) attached to the request for a mapping tile to determine that a same wireless device 110 is again issuing a request for a mapping tile. The mapping server 130 retrieves the requested mapping tile through issuance of a mapping database 150 query. The mapping server 130 can receive the requested mapping tile from the mapping database 150.

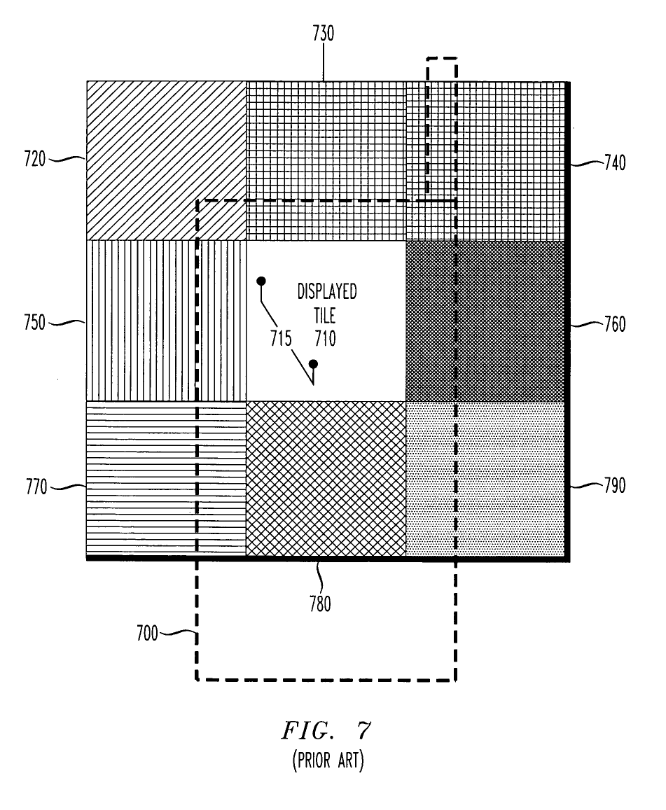

At step 380, a branch determination is made based on the proximity of the requested mapping tile to the previously transmitted mapping tile. If the mapping server 130 determines that the same wireless device 110 is issuing a request for a mapping tile and if the mapping server 130 determines that the currently requested mapping tile is adjacent, adjacent map tiles are shown in FIG. 7, the process 300 branches to step 390. Otherwise, the process branches to step 360.

At step 360, the mapping server 130 retrieves the previously stored search criteria for a point-of-interest, stored in step 320. The mapping server 130 issues a database query to the persistent database 140. The mapping server 130 can retrieve previously stored search criteria from persistent database 140 using a wireless device's 110 identification number, e.g., MIN. The mapping server 130 can receive a result of the database query, the result being the persistent search criteria in accordance with the principles disclosed herein. The persistent search criteria retrieved from persistent database 140 can then be used to issue a database query to the mapping database 150 to retrieve icon(s) for point-of-interest that are associated with the mapping tile retrieved in step 350.

At step 370, the mapping tile retrieved from mapping server 130 in step 350 and the icon(s) for point-of-interest retrieve from mapping server 130 in step 360 can together be transmitted to a wireless device 110 in response to panning.

At step 390, the mapping server 130 can simply transmit the mapping tile retrieved in step 350. The mapping tile is transmitted without any associated point-of-interest in step 390 since process 300 at this point has determined that the currently requested mapping tile is not being made in response to panning.

The invention serves Points of Interest on contiguous map tiles. Then to provide a service by which a client application can retrieve contiguous map tiles by providing the upper left and lower right points of a “bounding” box on the map. This map tile server is referred to herein as the “MapControl”.

The MapControl is a reusable widget capable of displaying map, routing, incident, Points of Interest and other forms of data in a generic manner. It also allows a user to pan, zoom and change locations. The control contains an optional Titlebar, an arbitrary number of layers and a framework for dispatching events to each layer.

The mapping framework consists of a MapLayerControl that contains a list of MapLayers. This MapLayerControl descends from a TitleableScreen that provides an optional, configurable Title control. The MapLayerControl also handles double buffering (for devices that do not provide it). It also contains methods for accessing location, viewport and zoom details. It provides a mechanism for subclasses to registered layers and events. Since it is possible for different layers to require different priorities for each event, it allows the registration of a priority for each event in each layer.

The MapLayerControl provides a generic mechanism to render layers of map detail. The MapControl contains MapLayers and functions for accessing the layers. The MapLayerControl provides an interface for classes to be able to access the current viewport, the current center location and zoom level.

The MapLayerControl allows subclasses to register the order that events traverse the layers. When an event occurs the control will find the layer order in its EventPriorityMap, then it will send the event to each layer. If the event is consumed by a layer, it is not passed onto successive layers. If there is no registered order for a given event, the event will traverse through the layers in the order that they were added to the control. MapLayers will have a pointer to a MapLayerControl so that they can query for relevant mapping information (e.g. mapscale, center point, viewport, etc).

MapLayer is superclasses that will contain all MapTiles provide interfaces to get information and act upon it for each tile.

All MapLayers contain the caching logic. MapTiles can be configured to be different sizes according to the expected data size of each tile. The MapLayer superclass will define the onViewportChanged method; this is necessary so that it knows which tiles are no longer relevant and which tiles need to be downloaded. The threshold for triggering a new set of tiles will be determined by its subclasses.

MapTiles are the units that the MapLayer class will manipulate. The size of the each MapTile is determined by the bounding box.

Layer Priorities represent the order in which the events will ‘visit’ the layers. Each layer evaluates an event and returns its consumed state. If the event is not consumed by a layer (or if it is not consumable at all), the event visits the next layer respectively. The subclass of the MapLayerControl is in charge of establishing the relationships between events and layers. It decides which layers will be added, the order that specific events will visit the layers as well as the mapping between key codes and events.

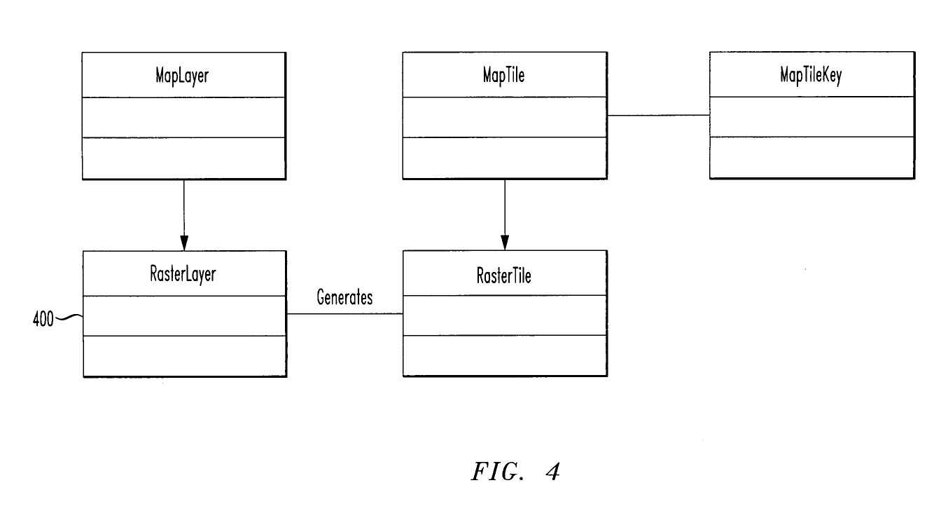

FIG. 4 shows an exemplary RasterLayer, in accordance with the principles of the present invention.

In particular, as shown in FIG. 4, RasterLayer 400—The RasterLayer 400 is a Layer representing the Map itself as it is dispensed from the server. No addition items like Points-of-interest or traffic incidents.

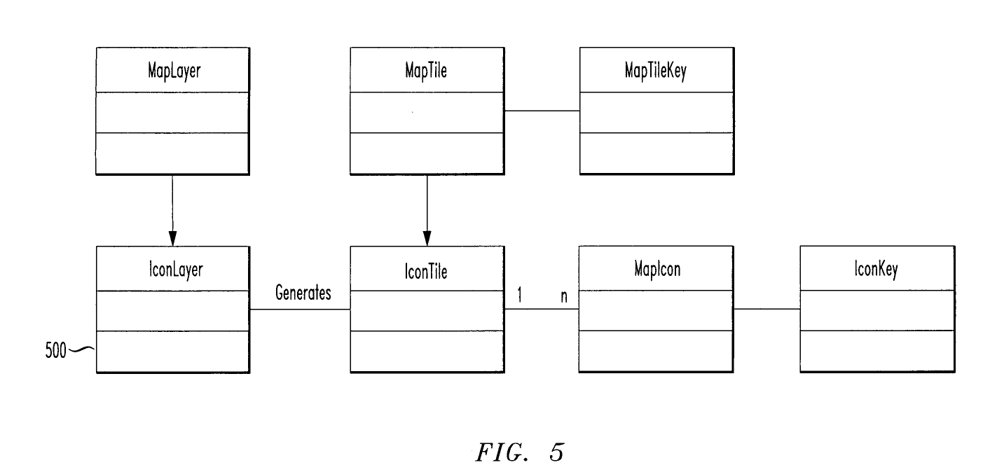

FIG. 5 shows an exemplary IconLayer 500, in accordance with the principles of the present invention.

In particular, as shown in FIG. 5, IconLayer 500—Layer represented by Points-of-interest and their respective location. MapIcons represent Points-of-interest.

FIG. 6 shows a plurality of mapping tiles that make up a larger map area, in accordance with the principles of the present invention.

In particular, as shown in FIG. 6, a plurality of mapping tiles 610-690 make up a larger map area. Mapping tile 610 is loaded into memory of a wireless device 110, such as a cell phone. Upon initial startup of the relevant application, the central mapping tile 610 is loaded first and displayed. The central mapping tile 610 includes various points-of-interest 615. Points-of-interest 615 can include an of a variety of points-of-interest that include address(es), restaurant(s), mass transit station(s), shopping, hospital(s)s, park(s), etc. A user typically enters a search criteria or selects a menu option criteria on the wireless device 110 to display desired points-of-interest 615.

Presuming that the user has not yet panning on the wireless device 110, the displayed mapping tile 610 is preferably downloaded or fetched first, followed by mapping tiles 620-690 as the user pans to an edge of displayed mapping tile 610. When a user pans to the edge of displayed mapping tile 610, the previously loaded mapping tile is deleted from a memory of the wireless device 110, and replaced with a new mapping tile, any of mapping tiles 720-790 depending upon the direction of panning. In accordance with the principles disclosed herein, panning to any of the mapping tiles 720-790 results in the points-of-interest 615 being persistently and automatically displayed on the mapping tiles 720-790. In contrast to the prior art, a user of the wireless device 110 need not enter search criteria for subsequent to panning for mapping tiles 720-790.

While the invention is disclosed herein as being performed by the mapping server 150, one of ordinary skill in the art would recognize that the features of persistent points-of-interest described herein can be instead by performed by the wireless device 110 itself. In such an alternate embodiment, the mapping server 150 would perform conventional mapping services and the wireless device 110 would identify a request for a neighboring tile, store persistent search criteria and persistently retrieve points-of-interest during panning.

The invention has particular application with wireless application developers that want to display large detailed images on a small display, e.g., the display of maps on a wireless device such as a cell phone or PDA. The invention also has applicability with vendors offer mapping functionality for portable, wireless devices in particular.

While the invention has been described with reference to the exemplary embodiments thereof, those skilled in the art will be able to make various modifications to the described embodiments of the invention without departing from the true spirit and scope of the invention.

What is claimed is:

1. A system for performing a persistent point-of-interest search, comprising:
a persistent search criteria module to identify a search criteria from a first mapping tile request and to store said search criteria in association with a particular wireless device; and
a mapping tile module to identify a neighboring mapping tile from a second mapping tile request and to perform a point-of-interest search for said neighboring mapping tile with said stored search criteria.

2. The system for performing a persistent point-of-interest search according to claim 1, wherein:
said first mapping tile request is from a cellular telephone.

3. The system for performing a persistent point-of-interest search according to claim 1, wherein:
said search criteria is for at least one restaurant.

4. The system for performing a persistent point-of-interest search according to claim 1, wherein:
said search criteria is for at least one form of mass transit.

5. The system for performing a persistent point-of-interest search according to claim 1, wherein:
said persistent search criteria module and said mapping tile module are remote from said particular wireless device.

6. A method of performing a persistent point-of-interest search, comprising:
identifying a search criteria from a first mapping tile request;
storing said search criteria in association with a particular wireless device;
identifying a neighboring mapping tile from a second mapping tile request; and
performing a point-of-interest search for said neighboring mapping tile with said stored search criteria.

7. The method of performing a persistent point-of-interest search according to claim 6, wherein:
said first mapping tile request is from a cellular telephone.

8. The method of performing a persistent point-of-interest search according to claim 6, wherein:
said search criteria is for at least one restaurant.

9. The method of performing a persistent point-of-interest search according to claim 6, wherein:
said search criteria is for at least one form of mass transit.

10. Apparatus for performing a persistent point-of-interest search, comprising:
means for identifying a search criteria from a first mapping tile request;
means for storing said search criteria in association with a particular wireless device;
means for identifying a neighboring mapping tile from a second mapping tile request; and
means for performing a point-of-interest search for said neighboring mapping tile with said stored search criteria.

11. The apparatus for performing a persistent point-of-interest search according to claim 10, wherein:
said first mapping tile request is from a cellular telephone.

12. The apparatus for performing a persistent point-of-interest search according to claim 10, wherein:
said wireless device includes a cell phone.

13. The apparatus for fetching a pan-able image for display on a wireless device according to claim 10, wherein:
said search criteria is for at least one restaurant.

14. The apparatus for fetching a pan-able image for display on a wireless device according to claim 10, wherein:
said search criteria is for at least one form of mass transit.

15. The apparatus for fetching a pan-able image for display on a wireless device according to claim 10, wherein:
said means for identifying a search criteria and said means for performing a point-of-interest search are remote from said wireless device.
